(19) United States
(12) Patent Application Publication
(10) Pub. No.: US 2011/0011269 A1
(43) Pub. Date: Jan. 20, 2011

(54) GRAIN WINE MANUFACTURING KIT USING A FILTER BAG

(76) Inventor: Jihoon Choi, Surrey (CA)

Correspondence Address: EDWARDS ANGELL PALMER & DODGE LLP, P.O. BOX 55874, BOSTON, MA, 02205, US

(21) Appl. No.: 12/865,811

(22) PCT Filed: Feb. 2, 2009
(86) PCT No.: PCT/KR09/00511

§ 371 Date: Aug. 2, 2010

(30) Foreign Application Priority Data
Feb. 2, 2008 (KR) 10-2008-0010895

(51) Int. Cl. C12G 3/02

(52) U.S. Cl. 99/276

(57) ABSTRACT

This invention provides a grain wine manufacturing kit which enables a consumer to manufacture grain wine easily. The disclosed gain wine manufacturing kit comprises a filter bag; and grain wine fermentation ingredients including dried and steamed grain and fermentation microorganisms which are filled in the filter bag.

### TECHNICAL FIELD

The present invention relates to production of fermented liquors, and more particularly, to manufacturing of grain wine.

### BACKGROUND ART

Grain wine means alcoholic beverages obtained by fermenting grains.

Commercial grain wine manufactured in breweries generally contains additives preventing deterioration and/or putrefaction during circulation in the market. However, such additives may degrade the taste of grain wine and may be harmful to the health of consumers. Such additives may also be a cause of hangover.

Therefore, the consumers who want to comfortably enjoy grain wine containing no additives, need to manufacture grain wine by themselves in their own homes.

A traditional method for manufacturing grain wine such as “Makgeolli”, which means unrefined rice wine in Korea, comprises many steps: steeping rice with water for about 2 hours; leaving the steeped rice on a sieve tray for about 1 hour to remove excess water; steaming the steeped rice for about 1 hour; drying the steamed rice; fermenting the dried rice with “Nurook”, which is a kind of mold culture made from fermenting fungus such as aspergillus oryzae, in water for about two weeks; and, after the completion of the fermentation, removing the rice residue by filtering fermented mixture.

However, such steps used in the traditional method are too cumbersome to be performed easily at home. Thus, it is very difficult for customers to perform such a traditional method by themselves in their own homes.

### DISCLOSURE OF INVENTION

The present invention provides a grain wine manufacturing kit enabling a user to conveniently manufacture grain wine.

According to an aspect of the present invention, there is provided a grain wine manufacturing kit comprising: a filter bag; and ‘grain wine fermentation ingredients’ including steamed-and-dried grains and fermenting microorganisms, the grain wine fermentation ingredients being contained in the filter bag.

In the present invention, the filter bag means a bag made of a material having water-insolubility, water-permeability, and porosity enough to substantially prevent the dry or wet fermentation ingredients from freely passing through the bag. The filter bag may be in any shape.

The water-insolubility of the filter bag is an important factor to allow the filter bag to maintain its mechanical strength while being in contact with water during fermentation. If the mechanical strength of the filter bag is weaken due to contact with water, the filter bag may rupture, thus, a significant amount of the fermentation ingredients may leak out of the filter bag. In that case, an additional filtering process is required to obtain clear grain wine, which complicates manufacturing of grain wine. Furthermore, if the filter bag is water-soluble, the obtained grain wine may be contaminated by water-soluble components of the filter bag. Thus, it is very preferable that the filter bag has water-insolubility.

The water-permeability of the filter bag is an important factor to allow water, which is a reaction medium for the fermentation reaction, to be supplied into the filter bag. When the filter bag containing fermentation ingredients is placed in a container and water is poured into the container, the water permeates into the filter bag. The water permeated into the filter bag serves as a reaction medium inducing the fermentation reaction of the fermentation ingredients in the filter bag. In addition, the water-permeability of the filter bag is also an important factor to allow grain wine components, such as ethanol, which are produced in the filter bag during the fermentation reaction, to diffuse out of the filter bag.

Before starting the grain wine manufacturing, the porosity of the filter bag substantially prevent the dry fermentation ingredients from passing out of the filter bag. During the grain wine manufacturing, the porosity of the filter bag also substantially prevent the wet fermentation ingredients from passing out of the filter bag. The pores of the filter bag facilitate water permeation into the filter bag. The pores of the filter bag also allow grain wine components, such as ethanol, which are produced in the filter bag during the fermentation reaction, to more easily diffuse out of the filter bag.

Examples of the filter bag include a synthetic fiber cloth bag, a natural fiber cloth bag, and the like. Preferably, the filter bag may be a natural fiber cloth bag because the natural fiber cloth is an environmentally-friendly material containing no chemicals to contaminate grain wine. More preferably, the filter bag may be made of cotton cloth, hemp cloth, or the like.

The fermentation ingredients for producing grain wine are contained in the filter bag. The grain wine fermentation ingredients may comprise steamed-and-dried grains and fermenting microorganisms.

The steamed-and-dried grains may be prepared by any of known methods for steaming and drying grains. Thus, a detailed description of a method of preparing the dry steamed grains will not be provided here. The grains may be, for example, rice, glutinous rice, hulled millet, corn, or combinations thereof. The grains may be in the form of polished granules or powder.

The fermenting microorganisms may be, for example, aspergillus ferment, yeast ferment, or a combination thereof. The fermenting microorganisms may be in the form of dried granules or dried powder.

The amount of the fermenting microorganism in the grain wine fermentation ingredients is not limited. If a brewing aspergillus ferment is used, the amount of the fermenting microorganism may be, for example, in a range of about 10 to about 30 parts by weight based on 100 parts by weight of the steamed-and-dried grains. If a brewing yeast ferment is used, the amount of the fermenting microorganism may be, for example, in a range of about 0.05 to about 0.15 parts by weight based on 100 parts by weight of the steamed-and-dried grains.

An embodiment of a grain wine manufacturing kit according to the present invention may be manufactured, for example, by placing grain wine fermentation ingredients in a sack shaped filter bag via an opening of the sack shaped filter bag and sewing or fastening the opening of the sack shaped filter bag. Another embodiment of the grain wine manufacturing kit may be manufactured, for example, by placing grain wine fermentation ingredients between two sheets of filter cloth and sewing the outer edge of the filter cloth. Besides, any of a variety of methods may be used to seal the grain wine fermentation ingredients in the filter bag. When the sack shaped filter bag is used, it may be optional to seal the upper opening of the filter bag. In case that the upper opening of the sack shaped filter bag is to be hung on an upper lid of a container in which fermentation is to occur, since the grain wine fermentation ingredients are unlikely to leak through the upper opening of the filter bag, it may be unnecessary to seal the upper opening of the filter bag.

For example, a grain wine manufacturing kit according to embodiments of the present invention may be distributed in the market after being packed, together with a dehumidifying agent, in a vacuum packaging container. However, it is not necessary to add additives, such as an antiseptic agent, to the grain wine fermentation ingredients.

In order to manufacture grain wine, a grain wine manufacturing kit according to the present invention is placed in a jar which contains water, and left at room temperature for a period of time (for example, about two weeks) to complete the fermentation. After the fermentation, by simply pulling out the used kit from the jar, we can obtain clear grain wine which remains in the jar. Therefore, a grain wine manufacturing kit according to the present invention allows a user to very conveniently obtain clear grain wine in a jar, without performing cumbersome steps, such as steeping grains in water, removing excess water from the steeped grains, steaming and drying the steeped grains, and, in particular, filtering residues out of the fermented ingredient mixture.

### BEST MODE FOR CARRYING OUT THE INVENTION

### EXAMPLE

First, 3 kg of glutinous rice was soaked with water for 10 hours in a container which was filled with 3 L of water. Then, the soaked glutinous rice was placed on a sieve tray for 1 hour to remove excess water and was then steamed in a steamer at 100° C. for 100 minutes. The steamed glutinous rice was dried at room temperature for 7 hours using an air blower.

3 kg of the steamed-and-dried glutinous rice, 300 g of “nurook”(a culture of brewing aspergillus ferment), and 5 g of brewing yeast ferment were mixed to prepare ‘grain wine fermentation ingredients’.

3,305 g of the grain wine fermentation ingredients were put into a sack-shaped cotton cloth bag via an opening of the bag. Then, by sewing the opening of the cotton cloth bag using cotton yarn, a grain wine manufacturing kit was obtained.

Next, the grain wine manufacturing kit was placed in a 15 L glass bottle, and 10 L of purified water was added into the glass bottle. Then, the glass bottle was covered with a lid, and left at room temperature for 2 weeks to complete the fermentation. After the 2-week fermentation, the used kit was removed from the glass bottle, and grain wine remained in the glass bottle.

The grain wine in the glass bottle was observed with eyes. As a result, substantially none of the granular residues of the grain wine fermentation ingredients were observed. The alcohol content of the grain wine in the glass bottle was 8% by weight. Furthermore, the grain wine in the glass bottle tasted like traditional glutinous rice wine.

These results support that, none the less because the grain wine fermentation ingredients are restricted within the filter bag, the grain wine fermentation ingredients can be effectively fermented.

### INDUSTRIAL APPLICABILITY

A grain wine manufacturing kit according to the present invention allows a user to very conveniently obtain clear grain wine in a jar, without performing cumbersome steps, such as steeping grains in water, removing excess water from the steeped grains, steaming and drying the steeped grains, and, in particular, filtering residues out of the fermented ingredients mixture.

1. A grain wine manufacturing kit comprising:
a filter bag; and
grain wine fermentation ingredients comprising steamed-and-dried grains and fermenting microorganisms, the grain wine fermentation ingredients being contained in the filter bag.

2. The grain wine manufacturing kit of claim 1, wherein the filter bag is a cotton cloth bag or a hemp cloth bag.
